(19) United States
(12) Patent Application Publication
(10) Pub. No.: US 2018/0265330 A1
(43) Pub. Date: Sep. 20, 2018

(54) ELEVATOR SYSTEM AND A METHOD OF OPERATING ELEVATOR CARS IN A MULTI-CAR ELEVATOR SYSTEM

(71) Applicant: Kone Corporation, Helsinki (FI)

(72) Inventors: Ilpo HAIPUS, Nummela (FI); Antti KALLIONIEMI, Jokela (FI)

(73) Assignee: Kone Corporation, Helsinki (FI)

(21) Appl. No.: 15/987,226

(22) Filed: May 23, 2018

Related U.S. Application Data
(63) Continuation of application No. PCT/FI2015/050961, filed on Dec. 31, 2015.

(51) Int. Cl. B66B 9/00; B66B 1/28; B66B 1/24

(52) U.S. Cl. CPC B66B 9/003; B66B 1/28; B66B 2201/303; B66B 1/2491; B66B 2201/34; B66B 1/2466

(57) ABSTRACT

According to an aspect, there is provided an elevator system comprising an elevator control apparatus configured to operate elevator cars in two parallel vertical trajectories, wherein the elevator cars are configured to move in a closed loop up along a first vertical trajectory and down along a second vertical trajectory, The first vertical trajectory and the second vertical trajectory are at least partly shared by a first group of elevator cars and a second group of elevators cars, wherein the first group and the second group at least partly are configured to operate at different maximum speeds.

This application is a continuation of PCT International Application No. PCT/FI2015/050961 which has an International filing date of Dec. 31, 2015, the entire contents of which are incorporated herein by reference.

### BACKGROUND

Traditionally an elevator car is arranged to move up and down in a dedicated elevator shaft, in other words, there is one moving elevator car in one elevator shaft. Another possibility is to implement a closed loop where a plurality of elevator cars move along two parallel vertical trajectories such that the elevator cars move up along a first trajectory, then turn and return down long a second vertical trajectory.

Space is always a critical factor in building design, and elevator shafts always require a certain amount of space in a building. Therefore, it would be desirable to find an elevator system that uses space wisely and at the same time provides an efficient transportation solution.

### SUMMARY

According to a first aspect of the invention, there is provided an elevator system. The elevator system comprises an elevator control apparatus configured to operate elevator cars in two parallel vertical trajectories, wherein the elevator cars are configured to move in a closed loop up along a first vertical trajectory and down along a second vertical trajectory. The first vertical trajectory and the second vertical trajectory are at least partly shared by a first group of elevator cars and a second group of elevators cars, wherein the first group and the second group at least partly are configured to operate at different maximum speeds.

In one embodiment, the first group is a shuttle group and the second group is a local group.

In one embodiment, alternatively or in addition, at least one of the first vertical trajectory and the second vertical trajectory is divided into at least two sectors.

In one embodiment, alternatively or in addition, the elevator control apparatus is configured to apply different speed levels and/or safety distances for at least two sectors of the at least two sectors.

In one embodiment, alternatively or in addition, at least one of the first vertical trajectory and the second vertical trajectory is divided into at least two sectors for the first group, wherein each sector has a different maximum speed.

In one embodiment, alternatively or in addition, the elevator control apparatus is configured to determine the at least two sectors adaptively.

In one embodiment, alternatively or in addition, the elevator control apparatus is configured to apply a sector specific minimum safety distance between two consecutive elevator cars.

In one embodiment, alternatively or in addition, wherein the minimum safety distance of a sector depends on the maximum speed of the sector.

In one embodiment, alternatively or in addition, the first vertical trajectory and the second vertical trajectory are divided into at least two sectors for the second group of elevator cars, wherein each sector is operated by a separate set of elevator cars of the second group.

In one embodiment, alternatively or in addition, the elevator system comprises at least one additional return track between the first vertical trajectory and the second vertical trajectory for the second group.

In one embodiment, alternatively or in addition, the elevator system comprises at least one pit for at least one elevator car being in a standby mode.

In one embodiment, alternatively or in addition, the elevator control apparatus is configured to activate at least one elevator car being in the standby mode for the first group and/or the second group when traffic demand increases.

According to a second aspect of the invention, there is provided a method of operating elevator cars in a multi-car elevator system. The method comprises controlling elevator cars to move in a closed loop up along a first vertical trajectory and down along a second vertical trajectory, wherein the first vertical trajectory and the second vertical trajectory are shared at least partly by a first group of elevator cars and a second group of elevators cars, and operating the first group and the second group at least partly at different maximum speeds.

In one embodiment, the first group is a shuttle group and the second group is a local group.

In one embodiment, alternatively or in addition, the method further comprises dividing at least one of the first vertical trajectory and the second vertical trajectory into at least two sectors.

In one embodiment, alternatively or in addition, the method further comprises applying different speed levels and/or safety distances for at least two sectors of the at least two sectors.

In one embodiment, alternatively or in addition, the method further comprises dividing at least one of the first vertical trajectory and the second vertical trajectory into at least two sectors for the first group, wherein each sector has a different maximum speed.

In one embodiment, alternatively or in addition, the method further comprises determining the at least two sectors adaptively.

In one embodiment, alternatively or in addition, the method further comprises applying a sector specific minimum safety distance between two consecutive elevator cars.

In one embodiment, alternatively or in addition, wherein a minimum safety distance of a sector depends on the maximum speed of the sector.

In one embodiment, alternatively or in addition, the method further comprises dividing the first vertical trajectory and the second vertical trajectory into at least two sectors for the second group of elevator cars, and operating each sector by a separate set of elevator cars of the second group.

In one embodiment, alternatively or in addition, wherein the elevator system comprises at least one return track between the first vertical trajectory and the second vertical trajectory for the second group.

In one embodiment, alternatively or in addition, the method further comprises keeping at least one elevator car in at least one pit in a standby mode.

In one embodiment, alternatively or in addition, the method further comprises activating at least one elevator car being in the standby mode for the first group and/or the second group when traffic demand increases.

According to a third aspect of the invention, there is provided an apparatus of operating elevator cars in a multi-car elevator system. The apparatus comprises means for controlling elevator cars to move in a closed loop up along a first vertical trajectory and down along a second vertical trajectory, wherein the first vertical trajectory and the second vertical trajectory are shared at least partly by a first group of elevator cars and a second group of elevators cars, and means for operating the first group and the second group at least partly at different maximum speeds.

According to a fourth aspect of the invention, there is provided a computer program comprising program code, which when executed by at least one processing unit, causes the at least one processing unit to perform the method of the second aspect

In one embodiment, the computer program is embodied on a computer readable medium.

The means disclosed above may be implemented using at least one processor or at least one processor and at least one memory connected to the at least one processor, the memory storing program instructions to be executed by the at least one processor.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow diagram illustrating a method of operating a multi-car elevator system.

FIG. 2A is a system diagram illustrating a multi-car elevator system.

FIG. 2B is another system diagram illustrating a multi-car elevator system.

FIG. 3 is another system diagram illustrating a multi-car elevator system.

FIG. 4 is a block diagram illustrating an apparatus of operating elevator cars in a multi-car elevator system.

### DETAILED DESCRIPTION

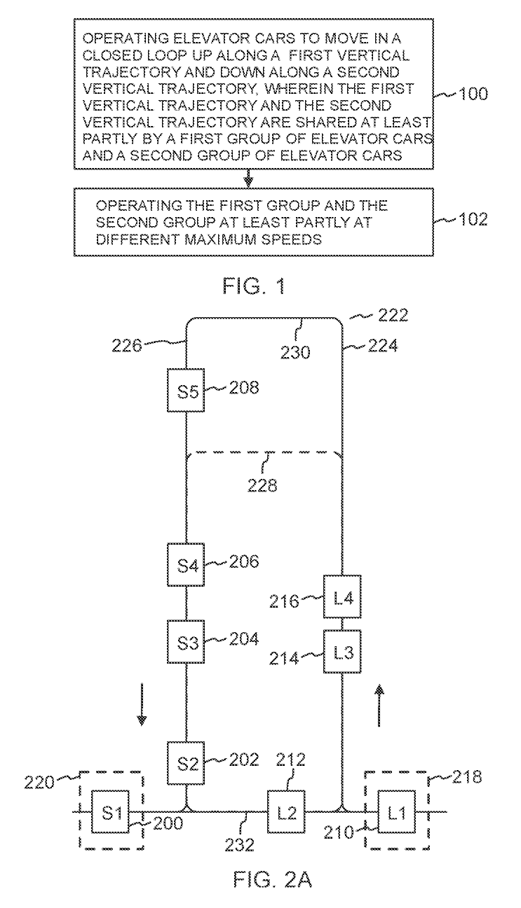

FIG. 1 is a flow diagram illustrating a method of operating a multi-car elevator system according to one embodiment.

The elevator system is a rope-less elevator system and comprises at least two parallel vertical trajectories, and elevator cars are configured to move in a closed loop up along a first vertical trajectory and down along a second vertical trajectory. The elevator cars thus use the same shafts and are able to change between the vertical trajectories horizontally. In 100, an elevator control apparatus is configured to operate the elevator cars in the two parallel vertical trajectories.

The first vertical trajectory and the second vertical trajectory are at least partly shared by a first group of elevator cars and a second group of elevators cars. In 102, the elevator control apparatus is configured to operate the first group and the second group at least partly at different maximum speeds. This means that a distance between two consecutive elevator cars may not always be fixed or static but may differ in time. This may also mean that there may be sectors in the first and/or second vertical trajectories within which maximum speeds of elevator cars within the first group may differ sector by sector.

This enables a solution where it is possible to minimize waiting times in high-rise multi-car elevator systems.

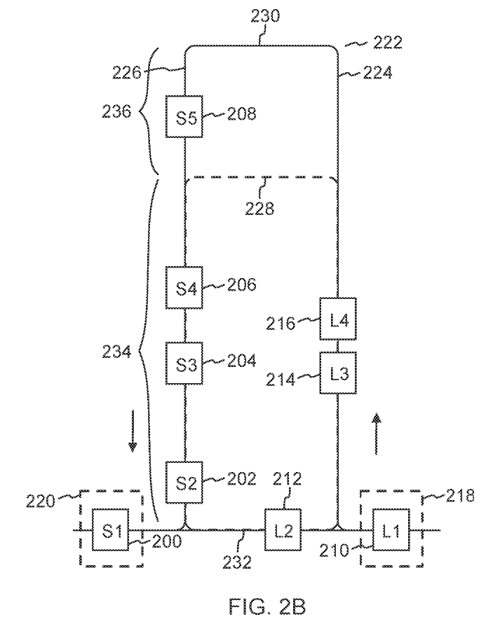

FIG. 2A illustrates an elevator system 222 comprising a first vertical trajectory 224 and a second vertical trajectory 226. Elevator cars 200-216 are configured to move in a loop up along the first vertical trajectory 224 and down along the second vertical trajectory 226. Horizontal sections 230, 232 of the loop enable the elevator cars 200-216 to move horizontally between the first vertical trajectory 224 and the second vertical trajectory 226.

FIG. 2A illustrates an embodiment in which the first vertical trajectory 224 and the second vertical trajectory 226 are at least partly shared by a first group of elevator cars 200-208 and a second group of elevator cars 210-216. The first group and the second group are configured to operate at least partly at different maximum speeds.

In FIG. 2A, the elevator cars 210-218 may form a local group and the elevators cars 200-208 may form a shuttle group. In one embodiment, the shuttle group has a higher maximum speed than the local group everywhere in the first vertical trajectory 224 and the second vertical trajectory 226.

When the first vertical trajectory 224 and the second vertical trajectory 226 are at least partly shared by the first group of elevator cars 200-208 and the second group of elevator cars 210-216, and the first group and the second group of elevator cars are configured to operate at least partly at different maximum speeds, one or more effects or advantages may be provided. For example, space needed for elevators in high rise buildings is saved, transport capacity is increased and total system complexity is simplified. Further, it is possible to minimize waiting times in high-rise multi-car elevator systems.

The local group may operate at a lower maximum speed than the shuttle group. However, due to the different maximum speeds, it may occur that elevator cars having a lower maximum speed block elevator cars having a higher maximum speed. To solve this problem, at least one optional return track 228 between the first vertical trajectory 224 and the second vertical trajectory 226 may be arranged in the elevator system 222. By using the at least one optional return track 228, one or more elevator cars may operate different routes and blocking between elevators cars belonging to the shuttle and/or local group may be prevented. In one embodiment, only the local group or the shuttle group may use the optional return track 228. In another embodiment, both groups may use the optional return track 228. The use of an optional return track 228 also shortens the cycle time of the elevator cars who are allowed to use the optional return track. Although FIG. 2A illustrates only one optional return track 228, in another embodiment, more than one may be provided.

Optionally, one or more pits 218, 220 may also be arranged. FIG. 2A illustrates that there are separate pits 218, 220 for the shuttle group and for the local group. In another embodiment, the shuttle group and the local group may share a single pit. In the one or more pits, one or more elevator cars can wait in a standby mode when the traffic demand is low. When the traffic demand increases, one or more cars may be activated for normal operation. Depending on traffic conditions the activated car(s) may be shuttle cars and/or local cars.

Transport capacity of the elevator system can be optimized for expected traffic by selecting a proper number of high speed elevator car and low speed elevator cars for serving passengers. Further, the transport capacity can be increased later if needed by adding one or more shuttle cars and/or local cars into the elevator system.

FIG. 2B illustrates a similar solution than the one disclosed in FIG. 2A with the exception that in FIG. 2B elevator cars within a single elevator group (for example, the shuttle group) may operate at different maximum speeds in different sections of the first and/or second vertical trajectories 224, 226. In the embodiment illustrated in FIG. 2B, two speed sectors 234, 236 have been configured for the elevator cars 200-208 belonging to the shuttle group. For example, the speed sector 234 may be a shuttle sector established between a ground floor and an office sector 236 in an upper part of a building. The office sector 236 is served also by the elevator cars of the shuttle group but it has a lower maximum speed than that of the shuttle sector 234. By using different speed sectors, it is possible to improve transport efficiency of the elevator system 222.

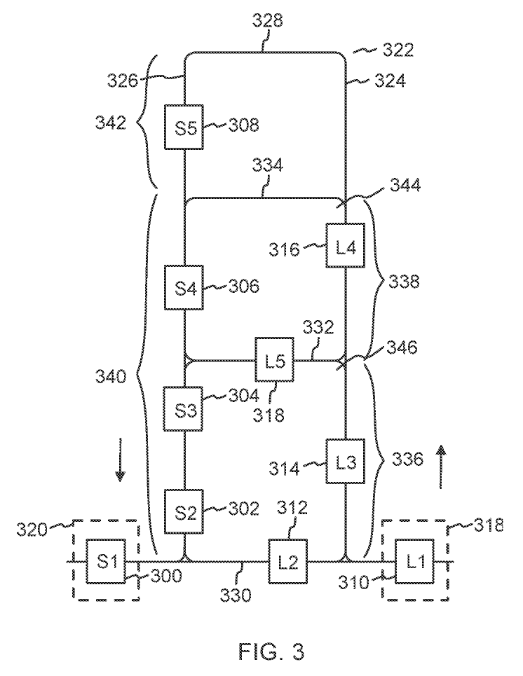

FIG. 3 illustrates an elevator system 322 comprising a first vertical trajectory 324 and a second vertical trajectory 326. Elevator cars 300-318 are configured to move in a loop up along the first vertical trajectory 324 and down along the second vertical trajectory 326. Horizontal sections 330-334 of the loop enable the elevator cars 300-318 to move horizontally between the first vertical trajectory 324 and the second vertical trajectory 326.

FIG. 3 illustrates embodiment in which the first vertical trajectory 324 and the second vertical trajectory 326 are at least partly shared by a first group of elevator cars 300-308 and a second group of elevator cars 310-318. The first group and second group of elevator are configured to operate at least partly at different maximum speeds.

In FIG. 3 the elevator cars 310-318 may form a local group and the elevators cars 300-308 may form a shuttle group. In one embodiment, the shuttle group has a higher maximum speed than the local group everywhere in the first vertical trajectory 324 and the second vertical trajectory 326.

Further, the local group may operate at a lower maximum speed than the shuttle group. However, due to the different maximum speeds, it may occur that elevator cars having a lower maximum speed block elevator cars having a higher maximum speed. To solve this problem, at least one optional return track 332, 334 may be arranged in the elevator system 322. By using the optional return tracks 332, 334, blocking between elevators cars belonging to the shuttle and/or local group may be prevented. In one embodiment, only the local group or the shuttle group may use the optional return tracks 332, 334. In another embodiment, both groups may use the optional return tracks 332, 334. Further, the use of the optional return tracks 332, 334 also shortens the cycle time of the elevator cars who are allowed to use the optional return track.

Optionally, one or more pits 318, 320 may also be arranged. FIG. 3 illustrates that there are separate pits 318, 320 for the shuttle group and the local group. In another embodiment, the shuttle group and the local group may share a single pit. In the one or more pits, one or more elevator cars can wait in a standby mode when the traffic demand is low. When the traffic demand increases, one or more cars may be activated for normal operation. Depending on the traffic conditions the activated car(s) may be shuttle cars and/or local cars.

The elevator system 322 may be configured to contain one or more subloops 344, 346. In FIG. 3, the elevator cars 312, 314 belonging to the local group may be configured to travel within the subloop 346. Similarly, the elevator cars 316, 318 may be configured to travel within the subloop 344 (i.e. within the defined by the horizontal sections 318, 330). If two subloops 344, 346 are configured to be used, it would mean that the elevator cars 316, 318 in the subloop 344 would travel along the horizontal section 332 towards the first vertical trajectory 324 while at the same time the elevator cars 312, 314 in the subloop 346 would travel along the horizontal section 332 towards the second vertical trajectory 326. Therefore, an elevator control apparatus controlling the elevator cars 300-318 may take into account locations of the elevator cars 312-318 when allocating calls to the elevator cars 312-318 so that there do not simultaneously exist two elevator cars in the horizontal section 332 going to opposite directions.

FIG. 3 also illustrates that elevator cars within a single elevator group (for example, the shuttle group) may operate at different maximum speeds in different sections of the first and/or second vertical trajectories 324, 326. In the embodiment illustrated in FIG. 3, two speed sectors 340, 342 have been configured for the elevator cars 300-308 belonging to the shuttle group. For example, the speed sector 340 may be a shuttle sector established between a ground floor and an office sector 342 in an upper part of a building. The office sector 342 then is served by the elevator cars of the shuttle group and it has a lower maximum speed than that of the shuttle sector 340.

Further, separate sectors may be configured also for the local group. In FIG. 3, the subloop 346 is a lower maximum speed sector 336 for the elevator cars 312, 314. Similarly, the subloop 346 is a lower maximum speed sector 338 for the elevator cars 316, 318.

In one embodiment of FIG. 3, the horizontal section 334 may be an optional return track for the elevator cars 316, 318 which normally use the horizontal section 328 to move from the first vertical trajectory 324 to the second vertical trajectory 326.

In any of the illustrated embodiments, a minimum safety distance may be configured to be applied between two consecutive elevator cars. The minimum safety distance may be different between two consecutive elevator cars belonging to the local group and between two consecutive elevator cars belonging to the shuttle group, and may be dependent on the maximum speeds. In other words, the minimum safety distance between two consecutive elevator cars belonging to the shuttle group may be longer than the minimum safety distance between two consecutive elevator cars belonging to the local group. The minimum safety distance between an elevator car of the local group and an elevator of the shuttle group may be determined based on the maximum speed of the elevator car of the shuttle group. When the minimum safety distance is made dependent on the maximum speeds, the elevator system is able to operate more efficiently.

In any of the illustrated embodiments, one or some of the elevator cars may be dimensioned for high speed transport, and the remaining elevator cars may be dimensioned for low speed transport. This means that high speed elevator cars and low speed elevator cars may structurally differ from each other.

In another embodiment, all the elevator cars are dimensioned so that they are capable of driving with high speed and low speed according to current traffic requirements. An elevator control system then determines which of the elevator cars are used as high speed shuttle cars and which of the elevator cars are used as low speed local cars. In one embodiment, the determination may be dynamic. This means, for example, that an elevator car may travel up along the first vertical trajectory 324 as an elevator car belonging to the local group and then start travelling down along the second vertical trajectory 326 as an elevator car belonging to the shuttle group.

By enabling a dynamic determination of the elevator cars, transport capacity of the elevator system can be optimized for expected traffic by selecting a proper number of high speed elevator car and low speed elevator cars for serving passengers.

In some embodiments, dimensioning of one or more elevator components associated with the first group of elevator cars may be at least partly different from dimensioning of the corresponding elevator components associated with the second group of elevator cars. This means that at least one component, such as a drive unit of an elevator car, associated with one of the cars of the first group may have dimensioning different from corresponding components associated with the second group of the elevator cars.

In any of the illustrated embodiments, one or more speed sectors may be variable and they may be dynamically redetermined based on at least one criterion, for example, current traffic conditions, time of day etc. Therefore, for example, at a first moment of time, the high speed sector of the shuttle group may be in an upper part of a building and the low speed sector may be near ground level, and at a second moment of time, the sectors may be reversed. This enables a solution that is able to accommodate to different traffic situations and is thus able to improve overall transport efficiency of the elevator system.

In any of the illustrated embodiments, in case of an evacuation situation, sectors can be redetermined so that low speed elevator cars collect people to a specific collecting floor(s) and high speed elevators move the passengers from the collecting floor(s) to the ground level.

In any of the illustrated embodiments, it is also possible to configure more than two different sectors with different speed levels and/or safety distance requirements. For example, there might be three different sectors (for example, a department store sector, a hotel sector, a tenant sector), and each of these sectors may use different speed levels and/or safety distance requirements.

The horizontal movement between the first and second vertical trajectories may be implemented using any suitable technique for that purpose. Further, each elevator car in the illustrated embodiments may include a linear motor, for example, a linear reluctance motor, and the elevator shaft may comprise stators for the linear motors. The stators may be commonly used by the first and second elevator groups of elevator cars.

In another embodiment, although two elevator groups have been illustrated above, it is possible to implement more than two elevator groups operating at different maximum speeds.

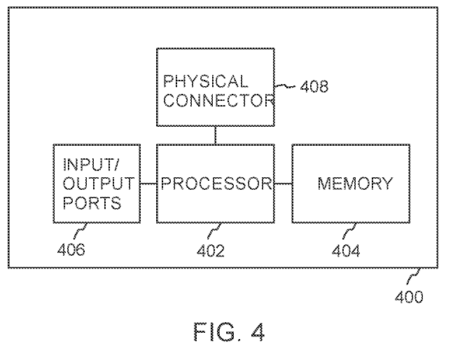

FIG. 4 illustrates a block diagram of an elevator control apparatus 400 configured to operate elevator cars in a multi-car elevator system. The apparatus 400 comprises at least one processor 402 connected to at least one memory 404. The at least one memory 404 may comprise at least one computer program which, when executed by the processor 402 or processors, causes the apparatus 400 to perform the programmed functionality. The apparatus 400 may also comprise input/output ports 406 and/or one or more physical connectors 408, which can be an Ethernet port, a Universal Serial Bus (USB) port, IEEE 1394 (FireWire) port, and/or RS-232 port. The illustrated components are not required or all-inclusive, as any components can deleted and other components can be added.

The elevator control apparatus 400 may be a control entity configured to implement only the above disclosed operating features, or it may be part of a larger elevator control entity, for example, a group controller.

The elevator control apparatus 400 comprises means for controlling elevator cars to move in a closed loop up along a first vertical trajectory and down along a second vertical trajectory, wherein the first vertical trajectory and the second vertical trajectory are shared at least partly by a first group of elevator cars and a second group of elevators cars, and means for operating the first group and the second group at least partly at different maximum speeds. The means may be implemented using at least one processor 402 or at least one processor 402 and at least one memory 404 connected to the at least one processor 402, the at least one memory 404 storing program instructions to be executed by the at least one processor 402.

The exemplary embodiments of the invention can be included within any suitable device, for example, including, servers, workstations, personal computers, laptop computers, capable of performing the processes of the exemplary embodiments. The exemplary embodiments may also store information relating to various processes described herein.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

All or a portion of the example embodiments can be conveniently implemented using one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments can be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An elevator system comprising:
an elevator control apparatus configured to operate elevator cars in two parallel vertical trajectories, wherein the elevator cars are configured to move in a closed loop up along a first vertical trajectory and down along a second vertical trajectory;
wherein the first vertical trajectory and the second vertical trajectory are at least partly shared by a first group of elevator cars and a second group of elevators cars, wherein the first group and the second group at least partly are configured to operate at different maximum speeds.

2. An elevator system according to claim 1, wherein the first group is a shuttle group and the second group is a local group.

3. An elevator system according to claim 1, wherein at least one of the first vertical trajectory and the second vertical trajectory is divided into at least two sectors.

4. An elevator system according to claim 3, wherein the elevator control apparatus is configured to apply different speed levels and/or safety distances for at least two sectors of the at least two sectors.

5. An elevator system according to claim 3, wherein at least one of the first vertical trajectory and the second vertical trajectory is divided into at least two sectors for the first group, wherein each sector has a different maximum speed.

6. An elevator system according to claim 3, wherein the elevator control apparatus is configured to determine the at least two sectors adaptively.

7. An elevator system according to claim 3, wherein the elevator control apparatus is configured to apply a sector specific minimum safety distance between two consecutive elevator cars.

8. An elevator system according to claim 7, wherein the minimum safety distance of a sector depends on the maximum speed of the sector.

9. An elevator system according to claim 3, wherein the first vertical trajectory and the second vertical trajectory are divided into at least two sectors for the second group of elevator cars, wherein each sector is operated by a separate set of elevator cars of the second group.

10. An elevator system according to claim 1, further comprising at least one additional return track between the first vertical trajectory and the second vertical trajectory for the second group.

11. An elevator system according to claim 1, further comprising at least one pit for at least one elevator car being in a standby mode.

12. An elevator system according to claim 11, wherein the elevator control apparatus is configured to activate at least one elevator car being in the standby mode for the first group and/or the second group when traffic demand increases.

13. A method of operating elevator cars in a multi-car elevator system, the method comprising:
controlling elevator cars to move in a closed loop up along a first vertical trajectory and down along a second vertical trajectory, wherein the first vertical trajectory and the second vertical trajectory are shared at least partly by a first group of elevator cars and a second group of elevators cars; and
operating the first group and the second group at least partly at different maximum speeds.

14. A method according to claim 13, wherein the first group is a shuttle group and the second group is a local group.

15. A method according to claim 13, further comprising:
dividing at least one of the first vertical trajectory and the second vertical trajectory into at least two sectors.

16. A method according to claim 15, further comprising:
applying different speed levels and/or safety distances for at least two sectors of the at least two sectors.

17. A method according to claim 15, further comprising:
dividing at least one of the first vertical trajectory and the second vertical trajectory into at least two sectors for the first group, wherein each sector has a different maximum speed.

18. A method according to claim 15, further comprising:
determining the at least two sectors adaptively.

19. A method according to claim 15, further comprising:
applying a sector specific minimum safety distance between two consecutive elevator cars.

20. A method according to claim 19, wherein the minimum safety distance of a sector depends on the maximum speed of the sector.

21. A method according to claim 15, further comprising:
dividing the first vertical trajectory and the second vertical trajectory into at least two sectors for the second group of elevator cars; and
operating each sector by a separate set of elevator cars of the second group.

22. A method according to claim 15, wherein the elevator system comprises at least one return track between the first vertical trajectory and the second vertical trajectory for the second group.

23. A method according to claim 15, further comprising:
keeping at least one elevator car in at least one pit in a standby mode.

24. A method according to claim 23, further comprising:
activating at least one elevator car being in the standby mode for the first group and/or the second group when traffic demand increases.

25. An apparatus of operating elevator cars in a multi-car elevator system, the apparatus comprising:
means for controlling elevator cars to move in a closed loop up along a first vertical trajectory and down along a second vertical trajectory, wherein the first vertical trajectory and the second vertical trajectory are shared at least partly by a first group of elevator cars and a second group of elevators cars; and
means for operating the first group and the second group at least partly at different maximum speeds.

26. A computer program comprising program code, which when executed by at least one processing unit, causes the at least one processing unit to perform the method of claim 13.

27. A computer program according to claim 26, wherein the computer program is embodied on a computer readable medium.
